(19) United States
(12) Patent Application Publication
(10) Pub. No.: US 2023/0032955 A1
(43) Pub. Date: Feb. 2, 2023

(54) CLAMPING DEVICE AND RELATED LEVER TYPE CAPPING MACHINE

(71) Applicant: FERRARI GROUP S.R.L., Montechiarugolo (PR) (IT)

(72) Inventor: Francesco MARCHINI, Montechiarugolo (PR) (IT)

(21) Appl. No.: 17/876,058

(22) Filed: Jul. 28, 2022

(30) Foreign Application Priority Data
Jul. 30, 2021 (IT) 102021000020603

(51) Int. Cl. B25B 1/10; B67B 1/04; B25B 1/12

(52) U.S. Cl. CPC B25B 1/103; B25B 1/125; B67B 1/045; B67B 2201/015

(57) ABSTRACT

A clamping device that can be installed in a capping machine for substantially cylindrical caps, including prisms that are placed in contact with each other so as to create a cavity in which a cap can be housed and are free to translate with respect to each other away from or towards an axis of symmetry of the cavity, in order to clamp and/or compress the cap housed in said cavity, said clamping device wherein a first and a second prism form a first pair and a third and a fourth prism form a second pair in which at least the first and/or second pair includes guiding means configured to allow a linear type translation and to perform an at least one-directional, preferably bidirectional retention action of the prisms of each pair with respect to each other.

### FIELD OF APPLICATION OF THE INVENTION

The present invention relates to a clamping device for preferably cylindrical caps, in particular made of cork or of other synthetic material and a relative lever type capping machine.

### BACKGROUND

In general, a lever capping machine comprises a frame composed of a base, a columnar element, perpendicular to the base, possibly a support for the bottles, a containment element protruding perpendicularly from the columnar element that contains a clamping system that clamp the caps and a lever placed at the end of the columnar element.

Said clamping system is composed of a plurality of prisms that, through spring mechanisms, when moved by a fork that slides along the arm, move closer to each other. At the centre of these prisms, a cavity is created in which the cap is placed which, with the prisms moving closer, is compressed. Simultaneously with the lowering of the lever, the cap is compressed and a substantially cylindrical rod element pushes the cap inside the bottle.

The criticality of these clamping systems lies in the fact that they do not provide prisms with constraints orthogonal to the sliding direction. The lack of these constraints implies that during the clamping step of the prisms around the cap, they can tilt, rotate and/or lose coplanarity. The problem with these undesired displacements of the prisms consists in the possibility of damaging the caps with the ends of the prisms during the clamping step. If a cap is scratched or damaged, there is a risk of not ensuring the tightness thereof and of ruining the content of the bottle because of contact with external air that might penetrate through the cracks produced by the prisms.

### EXPOSURE AND ADVANTAGES OF THE INVENTION

The technical problem underlying the present invention is to provide a clamping device for caps and a related lever type capping machine, in short capping machine, which makes it possible to remedy the drawback mentioned with reference to the prior art.

This problem is solved by a clamping device for caps and a related lever type capping machine as specified above.

The clamping device can be installed in a capping machine for substantially cylindrical caps, comprising prisms that are placed in contact with each other so as to create a cavity in which a cap can be housed and are free to translate with respect to each other away from or towards an axis of symmetry of the cavity in order to clamp and/or compress the cap housed in said cavity.

Said clamping device provides that a first and a second prism form a first pair and a third and a fourth prism form a second pair. In particular, at least the first and/or second pair comprises guiding means configured to allow a linear type translation and to perform an at least one-directional, preferably bidirectional retention action of the prisms of each pair with respect to each other.

The main advantage of said clamping device according to the present invention is in that it allows the clamping and/or the compression of a cap, preferably made of cork, without damaging it due to the misalignment of the prisms or to their rotation, before its insertion into the neck of a bottle. Preferably to optimize the coplanar and aligned movement of all the prisms and not only within each pair, the guiding means are further configured to allow a linear type translation and to perform an at least one-directional, preferably bidirectional retention action between the first pair with respect to the second pair.

Said capping machine which makes use of the clamping device as specified above is characterised in that it comprises the first and the second pair of the clamping device, housed within a containment element in which a fork slides, configured to bring the prisms closer/away, making them slide along the respective guiding means.

Advantageously, the capping machine allows a reliable capping and without damages to the caps, so as to avoid corrupting the liquids contained in the bottles due to the air ingress.

Said purposes and advantages are all achieved by the clamping device for caps and a related capping machine, object of the present invention, which is characterised by the provisions of the following claims.

### BRIEF DESCRIPTION OF THE DRAWINGS

These and other features will be more apparent from the following description of some embodiments illustrated by way of non-limiting example in the accompanying drawings.

FIG. 1 shows an exploded view of the clamping device for caps according to the invention;

FIG. 2 shows the clamping device for caps according to the invention with the lever in a vertical position and the prisms spaced apart;

FIG. 3 shows the clamping device for caps according to the invention with the lever in a horizontal position and the prisms clamped;

FIG. 4 shows the prisms according to the invention in a spaced position;

FIG. 5 shows the prisms according to the invention in a clamped position;

FIG. 6 shows an exploded view of the prisms according to the invention;

FIG. 6a shows a different view of an exploded view of the prisms according to the invention;

FIG. 6b shows a section of the prisms according to the invention;

FIG. 6c shows a plan view of the prisms in which the section of FIG. 6b is indicated;

FIG. 7 shows a capping machine according to the invention, which makes use of the clamping device represented in FIGS. 1 to 6.

### DESCRIPTION OF THE INVENTION

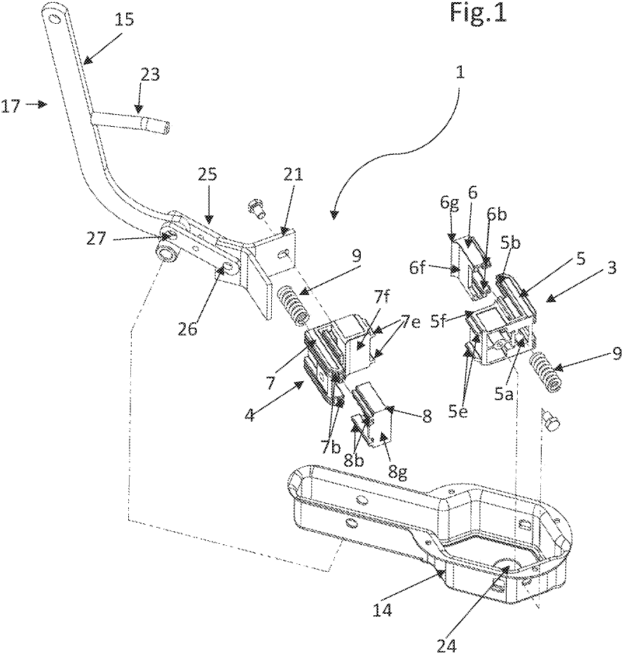

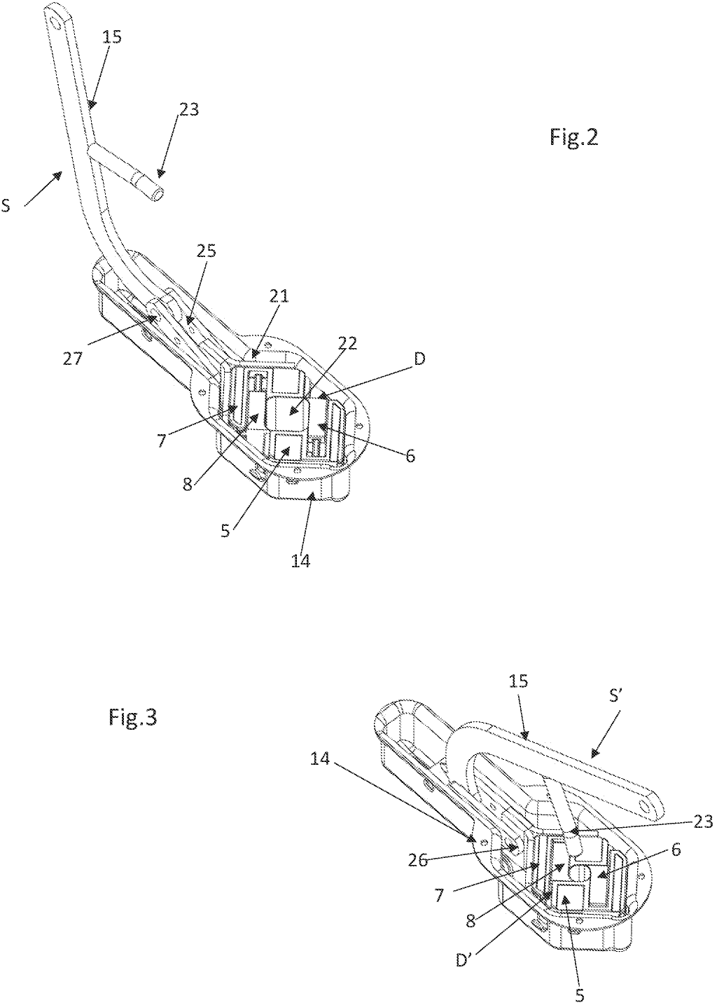

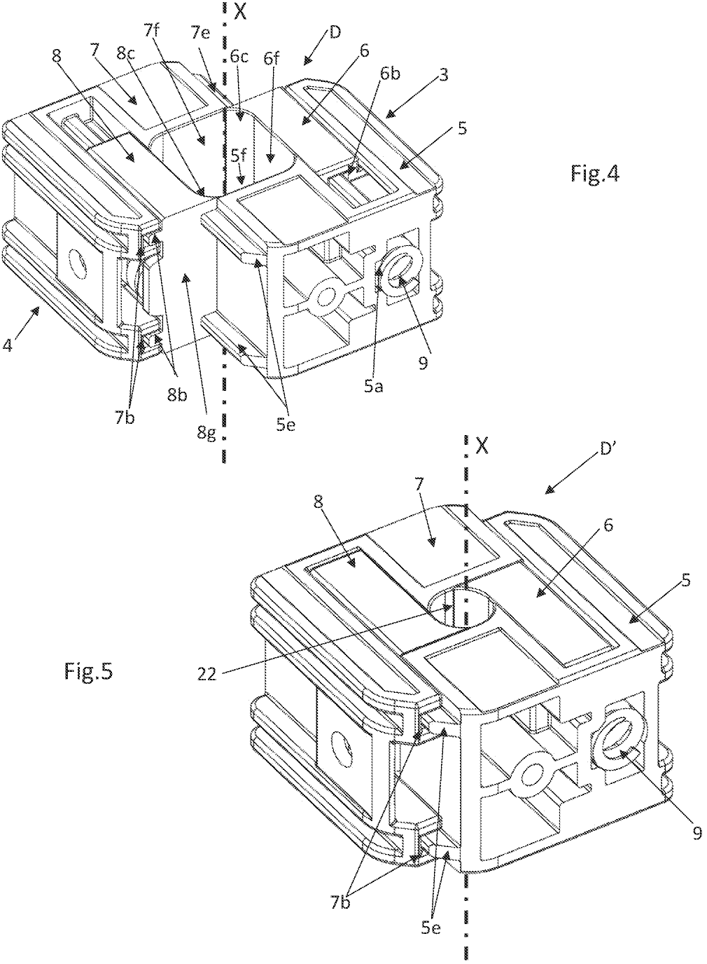

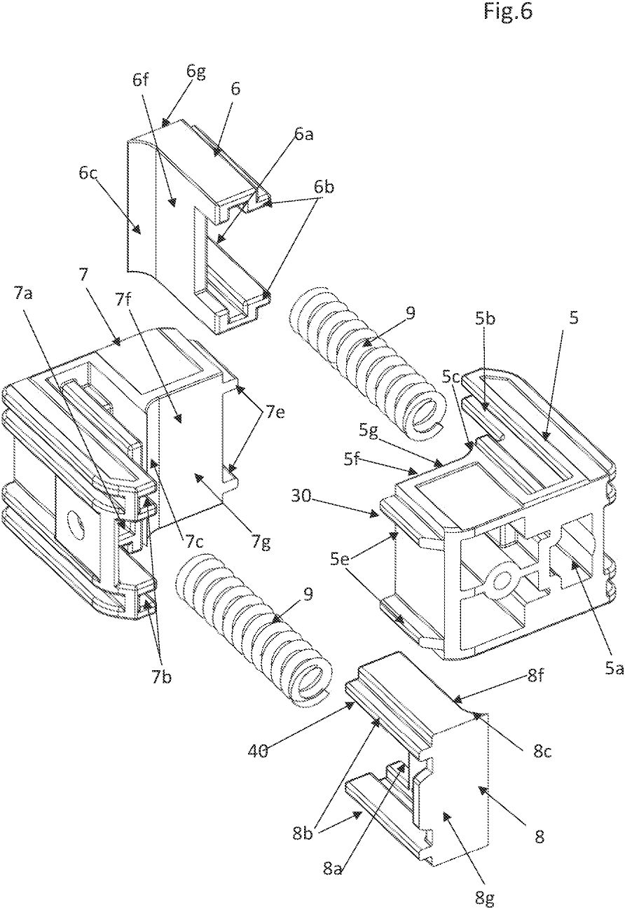

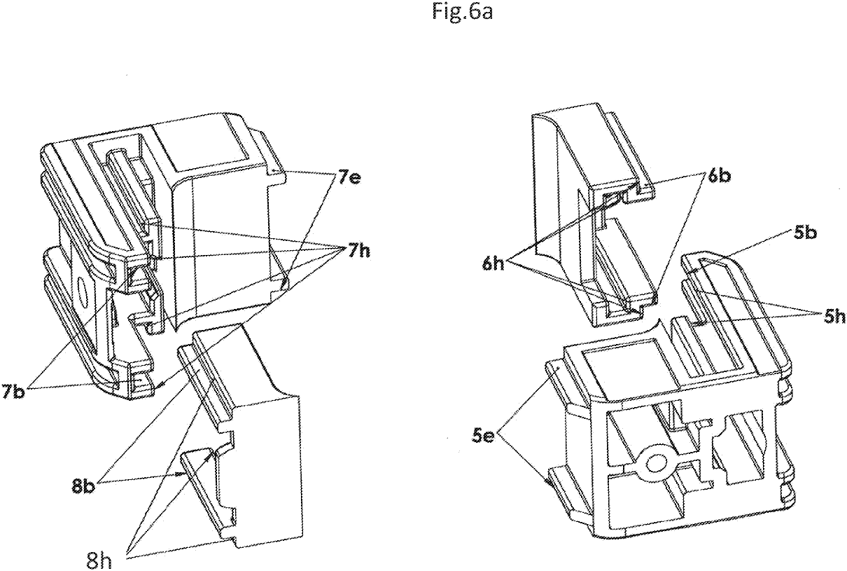

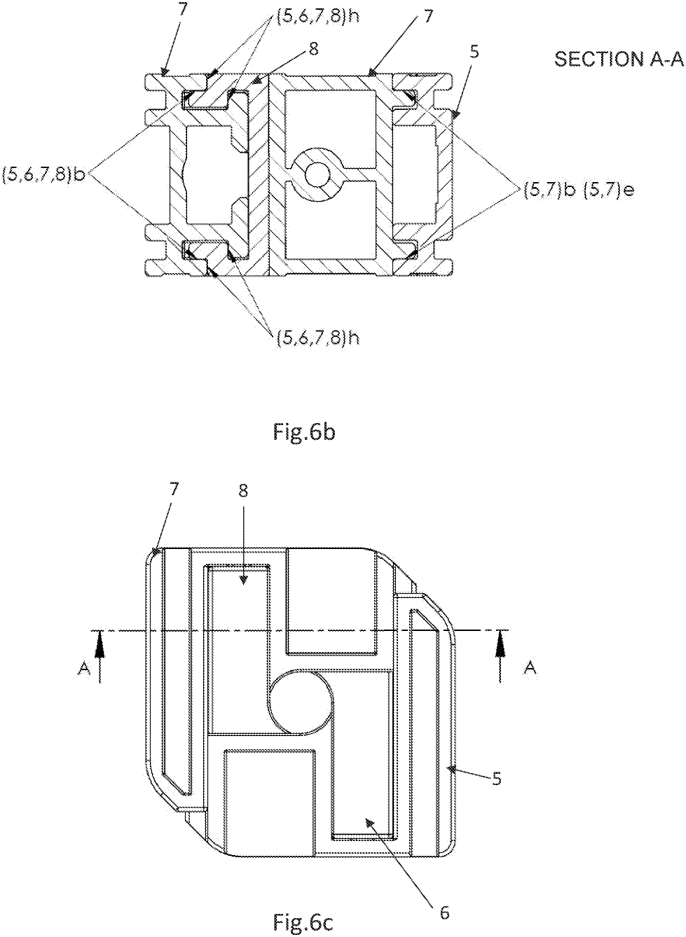

In a first aspect thereof, with reference to FIGS. 1 to 6, the present invention refers to a clamping device for caps, preferably cylindrical, which is indicated as a whole with 1.

The clamping device 1 can be installed in a capping machine for substantially cylindrical caps and comprises prisms 5, 6, 7, 8 that are placed in contact with each other so as to create a cavity 22 in which a cap can be housed.

Said prisms 5, 6, 7, 8 are free to translate with respect to each other moving towards an axis of symmetry X of the cavity 22 in order to clamp and/or compress the cap housed in said cavity 22. Said clamping device 1 is characterised in that a first and a second prism 5,6 form a first pair 3 and a third and a fourth prism 7, 8 form a second pair 4. At least the first and/or second pair 3, 4 comprises guiding means 30, 40 configured to allow a linear type translation and to perform an at least one-directional, preferably bidirectional retention action of the prisms of each pair 3, 4 with respect to each other. The retention action of the guiding means 30, of the prisms 5,6 of the pair 3, and/or of the guiding means 40, of the prisms 7,8 of the pair 4, can simply be of the one-directional type:
to prevent, for example, the vertical lifting of the prism 5 and/or 7 with respect to the other 6 and/or 8,
or to prevent the horizontal and orthogonal displacement when sliding for clamping the cap, of the prism 5 and/or 7 with respect to the other 6 and/or 8.

Said one-directional retention action also causes the two corresponding rotations to cancel each other.

A more complete embodiment, which is represented in the figures, provides that the guiding means 30, 40 perform a bidirectional retention action of the prisms of each pair 3, 4 with respect to each other.

Said bidirectional retention action causes all three possible rotations to cancel each other.

Therefore, in the most complete version, two translations and three rotations of the respective prisms of each pair 3 and/or 4 are prevented.

Advantageously, the presence of the guiding means 30, 40 prevents all the displacements that are different from the sliding direction for clamping the cap.

This has the advantage of ensuring that the prisms 5, 6, 7, 8 remain on the same plane throughout the clamping step around the cap.

This feature ensures that damages to the caps are avoided, which by getting scratched or nicked might allow air to enter the bottles.

Preferably, the guiding means 30, 40 are further configured to allow a linear type translation and to perform an at least one-directional, preferably bidirectional retention action between the first pair 3 with respect to the second pair 4.

The retention action of the guiding means 30, 40 of the first pair 3, with respect to the second pair 4, can simply be of a one-directional type. As represented in the figure, the guiding means 30, 40 prevent, for example, the vertical lifting of the first pair 3, with respect to the second pair 4 or vice versa.

Said one-directional retention action also causes the two corresponding rotations to cancel each other.

A more complete embodiment, not represented in the figures, can provide that the guiding means 30, 40 perform a bidirectional retention action of the first pair 3, with respect to the second pair 4.

Said bidirectional retention action causes all three possible rotations to cancel each other.

Therefore, in the most complete version, two translations and three rotations of the first pair 3, with respect to the second pair 4 and vice versa are prevented.

According to some preferred embodiments, the guiding means 30, 40 comprise first grooves and/or horizontal protrusions 5b, 7b obtained on the first and third prism 5, 7 and configured to receive slidingly corresponding second grooves and/or horizontal protrusions 6b, 8b of the respective second and fourth prisms 6,8.

Said first grooves and/or horizontal protrusions 5b, 7b and corresponding second grooves and/or horizontal protrusions 6b, 8b are configured to prevent the lifting or lowering in the vertical direction of the first prism 5 with respect to the second prism 6 and vice versa and of the third prism 7 with respect to the fourth prism 8 and vice versa.

Furthermore, the guiding means 30, 40 comprise first grooves and/or vertical protrusions 5h, 7h and corresponding second grooves and/or vertical protrusions 6h, 8h which are configured to prevent the horizontal and orthogonal displacement when sliding for clamping the cap, of the first prism 5 with respect to the second prism 6 and of the third prism 7 with respect to the fourth prism 8 and vice versa. Further, the guiding means 30, 40 preferably comprise secondary grooves and/or protrusions 5e, 7e respectively obtained on the first and third prism 5, 7 configured to cooperate slidingly with the corresponding first grooves and/or horizontal protrusions 7b, 5b and vice versa.

Said secondary grooves and/or protrusions 5e, 7e and the corresponding first grooves and/or horizontal protrusions 7b, 5b are configured to prevent the lifting or lowering in the vertical direction of the first pair 3, with respect to the second pair 4 and vice versa.

Preferably, in the embodiment of the invention represented in FIGS. 1 to 6, the guiding means 30, 40 comprise first horizontal grooves 5b, 7b made respectively on the first and third prism 5, 7 configured to receive slidingly corresponding second horizontal protrusions 6b, 8b made on the respective second and fourth prism 6, 8.

According to this embodiment, on the first and third prism 5, 7 two first horizontal grooves 5b, 7b are made which are parallel to each other and to the geometric sliding plane; preferably said grooves are placed one in proximity to a lower face and one in proximity to an upper face of the first and third prism 5, 7.

Concordantly, on the second and fourth prism 6, 8 a pair of second horizontal protrusions 6b, 8b are respectively made which are configured to slidingly fit into the respective pairs of first horizontal grooves 5b, 7b.

In the embodiment of the invention represented in FIGS. 1 to 6, further the guiding means 30, 40 may comprise first vertical protrusions 5h, 7h made respectively on the first and third prism 5, 7 and configured to receive slidingly corresponding second vertical grooves 6h, 8h made on the respective second and fourth prism 6, 8.

According to this embodiment, on the first and third prism 5, 7 two first vertical protrusions 5h, 7h are made which are parallel to each other and orthogonal to the geometric sliding plane; preferably said protrusions are placed one in proximity to a lower face and one in proximity to an upper face of the first and third prism 5, 7. In particular, the one placed in proximity to a lower face of the first and third prism 5, 7 prevents the lifting of the second and fourth prism 6, 8, while the one placed in proximity to an upper face of the first and third prism 5, 7 prevents the lowering of the second and fourth prism 6, 8.

Concordantly, on the second and fourth prism 6, 8 a pair of second vertical grooves 6h, 8h are respectively made which are configured to slidingly fit into the respective pairs of first vertical protrusions 5h, 7h.

Preferably, again according to this embodiment, the guiding means 30, 40 comprise secondary protrusions 5e, 7e respectively obtained on the first and third prism 5, 7 configured to slidingly fit into the corresponding first horizontal grooves 7b, 5b.

Said insertion preferably takes place once the second and fourth prism 6, 8 have run at least a sliding portion in the clamping direction and occupy at least part of the hollow housings 5a, 7a, obtained on the first 5 and third 7 prism.

Therefore the first prism 5, of the first pair 3 and the third prism 7 of the second pair 4 comprise the hollow housing 5a, 7a adapted to receive respectively the second and fourth prism 6, 8 during the clamping step.

According to some preferred embodiments of the invention, the hollow housing 5a, 7a of the first prism 5, of the first pair 3 and the third prism 7 of the second pair 4 can be further configured to receive an elastic element 9, configured to impart a force on the second and fourth prism 6, 8 in the away direction for the enlargement of the cavity 22.

According to the embodiment of the invention represented in FIGS. 1 to 6, the second and fourth prism 6, 8 comprise a seat 6a, 8a, for a portion of said elastic element 9 not contained in the hollow housing 5a, 7a. Said seat 6a, 8a is coaxial to the hollow housing 5a, 7a.

Preferably, the elastic element 9 is a spring.

Furthermore, the prisms 5, 6, 7, 8 may comprise a working surface 5f, 6f, 7f, 8f configured to contact the cap during the clamping of said prisms 5, 6, 7, 8, and preferably comprising a concave portion 5c, 6c, 7c, 8c so that the cavity 22 assumes a substantially cylindrical shape for the uniform clamping of the cap.

Preferably, the second 6 and fourth 8 prism comprise a flat end 6g, 8g configured to slide in contact with a flat portion 7g, 5g of the working surface 7f, 5f of the third 7 and first 5 prism, respectively.

Preferably, the first prism 5 during the clamping operation remains in a fixed position while the second, third, fourth prism 6, 7, 8 translate.

Preferably the prisms 5 ,6 ,7 ,8 are made of plastic material, e.g. teflon, or acetal resin to facilitate the mutual sliding and to maximize the useful life time.

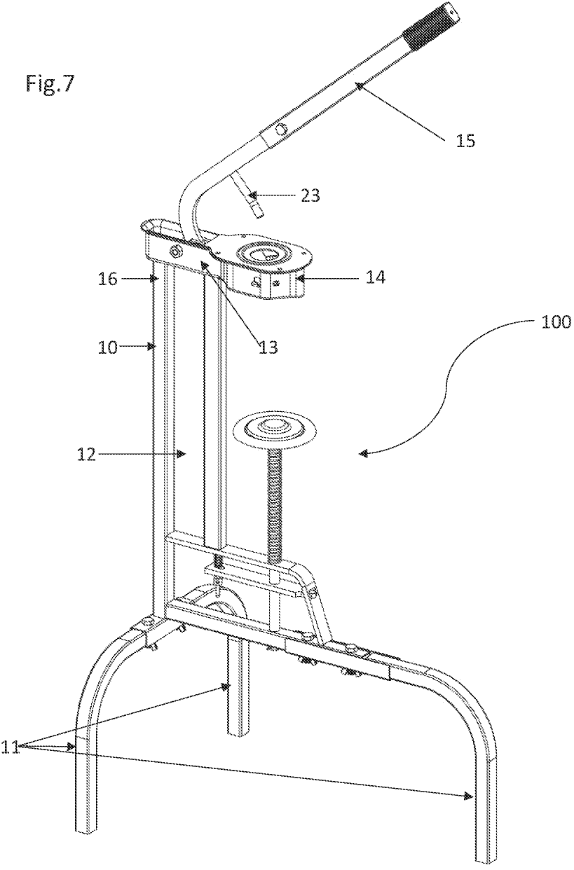

In a second aspect thereof, the present invention refers to a capping machine 100 (FIG. 7) which makes use of the clamping device 1 as specified above and in which the first and second pair of prisms 3, 4 of the clamping device 1 are housed within a containment element 14 in which a fork 21 slides, configured to bring the prisms 5, 6, 7, 8 closer/away, making them slide along the respective guiding means 30, 40.

Preferably, the first prism 5 is fixed to the containment element 14.

Preferably the third prism 7 is in contact with the fork 21 and preferably fixed, for example bolted, to the fork 21.

According to some preferred embodiments of the invention, the fork 21 has a Y shape embracing two sides of the third 7 prism, and is put into translation by rotation of a lever 15 operatively connected thereto.

Said containment element may comprise a hole 24 located at the cavity 22 defined by the prisms 5, 6, 7, 8 in a clamped configuration D′ and the lever 15 comprises a substantially cylindrical rod 23 configured to fit into the cavity 22 during the downward rotation of the lever 15.

In fact, the lever 15 can assume a substantially vertical raised position S corresponding to a spaced configuration D of the prisms 5, 6, 7, 8 or a substantially horizontal lowered position S′ corresponding to a clamped configuration D of the prisms 5, 6, 7, 8.

According to some preferred embodiments of the invention said capping machine 100 comprises a frame 10 in turn comprising a base 11, a columnar element 12, an arm 13 substantially perpendicular to said columnar element 12 and at the end of which it comprises the containment element 14. The lever 15 is placed at the end 16 of the columnar element 12 opposite the base 11.

Preferably, the lever 15 and the fork 21 are operatively connected through a connector 25 which is fixed with a first hinge 26 on the fork 21 and with a second hinge 27 to the end of the lever 15 distal from the substantially cylindrical rod 23; said connector 25 being suitable for displacing the fork 21 towards the containment element 14 simultaneously with the lowering of the lever 15.

Thanks to the connection between the lever 15 and the fork 21, by moving the lever from a raised position S, to a lowered position S′, the fork 21 moves the prisms 5, 6, 7, 8 closer making them slide in the respective guiding means 30, 40; in particular the second 6 and fourth 8 prism slide until they entirely occupy the housings dedicated to them, obtained on the first 5 and third 7 prism; once in proximity to the position for clamping and/or compressing the cap, the first 5 and third 7 prism come into contact and preferably engage with the respective secondary protrusions 5e, 7e in the reciprocal first horizontal grooves 5b, 7b; by sliding the one on the other, the first 5 and third 7 prism clamp and compress the cap which is pushed into the neck of the bottle by the substantially cylindrical rod 23 placed at the distal end by the columnar element 12 of the lever 15.

Advantageously, said capping machine 100 ensures a reliable capping and thanks to the use of the clamping device 1 object of the invention a capping without damages to the caps and consequently to the beverages contained in the bottles.

In order to satisfy further and contingent needs, a person skilled in the art may make numerous further modifications and variations to the above-described clamping system for caps and relative capping machine, all of which are included in the scope of protection of the present invention, as defined by the attached claims.

1. A clamping device that can be installed in a capping machine for substantially cylindrical caps, comprising prisms that are placed in contact with each other so as to create a cavity in which a cap can be housed and are free to translate with respect to each other away from or towards an axis of symmetry of the cavity, in order to clamp and/or compress the cap housed in said cavity, said clamping device wherein a first and a second prism form a first pair and a third and a fourth prism form a second pair in which at least the first and/or second pair comprises guiding means configured to allow a linear type translation and to perform an at least one-directional, preferably bidirectional retention action of the prisms of each pair with respect to each other.

2. The clamping device according to claim 1, wherein the guiding means are further configured to allow a linear type translation and to perform an at least one-directional, preferably bidirectional retention action between the first pair with respect to the second pair.

3. The clamping device according to claim 1, wherein the guiding means comprise first grooves and/or horizontal protrusions respectively obtained on the first and third prism and configured to receive slidingly corresponding second grooves and/or horizontal protrusions of the respective second and fourth prism to prevent the lifting or lowering in the vertical direction of the first prism with respect to the second prism and vice versa and of the third prism with respect to the fourth prism and vice versa.

4. The clamping device according to claim 1, wherein the guiding means comprise first grooves and/or vertical protrusions respectively obtained on the first and third prism and configured to receive slidingly corresponding second grooves and/or vertical protrusions of the respective second and fourth prism to prevent the horizontal and orthogonal displacement to the sliding for clamping the cap, of the first prism with respect to the second prism and vice versa, and of the third prism with respect to the fourth prism and vice versa.

5. The clamping device according to claim 1, wherein the guiding means further comprise secondary grooves and/or protrusions respectively obtained on the first and third prism configured to cooperate slidingly with the corresponding first grooves and/or horizontal protrusions to prevent the lifting or the lowering in the vertical direction of the first pair, with respect to the second pair and vice versa.

6. The clamping device according to claim 1, wherein the first prism, of the first pair and the third prism of the second pair comprise a hollow housing adapted to receive respectively the second and fourth prism during the clamping step and preferably also adapted to receive an elastic element configured to impart a force on the second and fourth prism in the away direction for the enlargement of the cavity.

7. The clamping device according to claim 6, wherein the elastic element is a spring.

8. The clamping device according to claim 1, wherein the first prism during the clamping operation remains in a fixed position while the second, third, fourth prism translate.

9. The clamping device according to claim 1, wherein the prisms are made of plastic material e.g. teflon or acetal resin.

10. The clamping device according to claim 1, wherein the prisms comprise a working surface configured to contact the cap during the clamping of said prisms and preferably comprising a concave portion so that the cavity assumes a substantially cylindrical shape for the uniform clamping of the cap.

11. The device according to claim 1 wherein, the second and fourth prism comprise a flat end configured to slide in contact with a flat portion of the working surface of the third and first prism, respectively.

12. A capping machine which makes use of a clamping device according to claim 1 wherein the first and second pair of the clamping device are housed within a containment element in which a fork slides, configured to bring the prisms closer/away, making them slide along the respective guiding means.

13. The capping machine according to claim 12, wherein the first prism is fixed to the containment element and preferably the third prism is in contact with the fork and preferably fixed to the fork.

14. The capping machine according to claim 12 wherein, the fork has a Y shape embracing two sides of the third prism, and is put into translation by rotation of a lever operatively connected thereto.

15. The capping machine according to claim 12 wherein, said containment element comprises a hole located at the cavity defined by the prisms in a clamped configuration and the lever comprises a substantially cylindrical rod configured to fit into the cavity during the downward rotation of the lever.

16. The capping machine according to claim 12, the lever, may assume a raised position corresponding to a spaced configuration of the prisms or a lowered position corresponding to the clamped configuration of the prisms.
